(19) United States
(12) Patent Application Publication
(10) Pub. No.: US 2016/0341068 A1
(43) Pub. Date: Nov. 24, 2016

(54) FIXED-VARIABLE VANE WITH POTTING IN GAP

(71) Applicant: United Technologies Corporation, Hartford, CT (US)

(72) Inventors: Thomas J. Robertson, JR., Glastonbury, CT (US); Enzo DiBenedetto, Kensington, CT (US); Nathan F. Champion, Enfield, CT (US); Niloofar Haghbin, Middletown, CT (US); Barry William Spaulding, III, Middletown, CT (US)

(21) Appl. No.: 14/880,519

(22) Filed: Oct. 12, 2015

Related U.S. Application Data
(60) Provisional application No. 62/062,974, filed on Oct. 13, 2014.

(51) Int. Cl. F01D 17/14; F01D 9/04

(52) U.S. Cl. CPC F01D 17/14; F01D 9/041; F05D 2220/32; F05D 2230/60; F05D 2230/30

(57) ABSTRACT

A fixed-variable vane assembly includes a vane that has a fixed airfoil section and a variable airfoil section next to the fixed airfoil section. The variable airfoil section is pivotably mounted at an end thereof in a joint with a variable joint gap that controls a size of an airfoil gap between the fixed airfoil section and the variable airfoil section. A potting material is located in the variable joint gap. The potting material locks the variable joint gap and locks in the size of the airfoil gap.

### CROSS-REFERENCE TO RELATED APPLICATION

The present disclosure claims priority to U.S. Provisional Patent Application No. 62/062,974, filed Oct. 13, 2014.

### STATEMENT REGARDING FEDERALLY SPONSORED RESEARCH OR DEVELOPMENT

This invention was made with government support under contract number FA8650-09-D-2923-DO0021 awarded by the United States Air Force. The government has certain rights in the invention.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

The high pressure turbine drives the high pressure compressor through an outer shaft to form a high spool, and the low pressure turbine drives the low pressure compressor through an inner shaft to form a low spool. The fan section may also be driven by the low inner shaft. A direct drive gas turbine engine includes a fan section driven by the low spool such that the low pressure compressor, low pressure turbine and fan section rotate at a common speed in a common direction. In some engine designs, the fan and/or compressor may include variable or fixed-variable vanes for controlling air flow into downstream rotating blades. A fixed-variable vane includes a fixed airfoil section and a variable airfoil section. There can be a gap between the sections to facilitate movement of the variable section, however, the gap can allow the escape of air flow between the sections, thus debiting aerodynamic efficiency.

### SUMMARY

A fixed-variable vane assembly according to an example of the present disclosure includes a vane that has a fixed airfoil section and a variable airfoil section next to the fixed airfoil section. The variable airfoil section is pivotably mounted at an end thereof in a joint with a variable joint gap that controls a size of an airfoil gap between the fixed airfoil section and the variable airfoil section. There is a potting material in the variable joint gap that locks the variable joint gap and locks in the size of the airfoil gap.

In a further embodiment of any of the foregoing embodiments, the joint includes a pivot member, a bushing that receives the pivot member, and a fixed receiver that has an opening that receives the bushing. The variable joint gap is between the bushing and a side of the opening.

In a further embodiment of any of the foregoing embodiments, the fixed receiver has a threaded outside surface that receives a nut.

In a further embodiment of any of the foregoing embodiments, the variable joint gap has a non-uniform dimension.

In a further embodiment of any of the foregoing embodiments, the potting material is a vibration damper.

In a further embodiment of any of the foregoing embodiments, the potting material is a polymeric-based material.

In a further embodiment of any of the foregoing embodiments, the potting material is an elastomeric-based material.

In a further embodiment of any of the foregoing embodiments, the potting material is a silicone-based material.

A fixed-variable vane assembly according to an example of the present disclosure includes a fixed airfoil section and a variable airfoil section next to the fixed airfoil section. The variable airfoil section includes at an end thereof a pivot member, a bushing that receives the pivot member, and a fixed receiver that has an opening that receives the bushing. The opening is larger than the bushing such that there is a variable joint gap between a side of the opening and the bushing and a potting material in the variable joint gap.

In a further embodiment of any of the foregoing embodiments, the fixed receiver has a threaded outside surface that receives a nut.

In a further embodiment of any of the foregoing embodiments, the variable joint gap has a non-uniform dimension.

In a further embodiment of any of the foregoing embodiments, the potting material is a vibration damper.

In a further embodiment of any of the foregoing embodiments, the potting material is a polymeric-based material.

In a further embodiment of any of the foregoing embodiments, the potting material is an elastomeric-based material.

In a further embodiment of any of the foregoing embodiments, the potting material is a silicone-based material.

In a further embodiment of any of the foregoing embodiments, the variable joint gap controls size of an airfoil gap between the fixed airfoil section and the variable airfoil section.

A method of establishing sizing of an airfoil gap in a fixed-variable vane assembly according to an example of the present disclosure includes pivotably mounting a variable airfoil section in a joint next to a fixed airfoil section, adjusting a size of a variable joint gap in the joint to obtain a desired size of an airfoil gap between the fixed airfoil section and the variable airfoil section, and applying a potting material in the variable joint gap to lock in the desired size of the airfoil gap.

In a further embodiment of any of the foregoing embodiments, the adjusting includes holding at least the variable airfoil section in a fixture.

In a further embodiment of any of the foregoing embodiments, the joint includes a pivot member, a bushing that receives the pivot member, and a fixed receiver that has an opening that receives the bushing. The variable joint gap is between the bushing and a side of the opening.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example gas turbine engine.

FIG. 2 illustrates an example fixed-variable vane assembly.

FIG. 3 illustrates an exploded view of an example fixed-variable vane assembly.

FIG. 4 illustrates a radially inward view of a joint of a fixed-variable vane assembly.

FIG. 5 illustrates a radially outward view of a joint of a fixed-variable vane assembly.

FIG. 6 illustrates a joint of a fixed-variable vane assembly having a non-uniformed variable joint gap.

### DETAILED DESCRIPTION

FIG. 1 schematically illustrates an example gas turbine engine 10 (“engine 10”). The engine 10 includes a fan section 12 that communicates air to a compressor section 14. The compressed air from the compressor section 14 is provided to a combustion section 16 where it is mixed with fuel and ignited to produce a high energy gas flow. The energetic gas flow is expanded through a turbine section 18, through an augmenter section 20, and finally through an exhaust nozzle section 22. The engine 10 is generally arranged along central engine axis A.

The example engine 10 is a two spool engine architecture that may be utilized for flight conditions with high Mach number flight speeds. However, the examples herein are not limited to such engine architectures and may be applied to other types of turbomachinery, such as, but not limited to, geared turbine engine architectures, three-spool turbine engine architectures, direct drive turbine engine architectures, ground-based turbine engines, and other tubomachinery that would benefit from this disclosure.

The engine 10 is a mixed flow turbofan engine that includes a core flow passage 24 for core flow C through the compressor section 14, combustion section 16, and turbine section 18. A first annular bypass passage 26 is arranged annularly about the core flow path C for a first bypass flow B1 about an engine core 28. The engine 10 also includes a second bypass passage 30 disposed radially outward of the first bypass passage 26 for a second bypass flow B2.

Incoming air, represented at F, is initially compressed by first and second fan stages 32/34 within the fan section 12. The fan stages 32/34 include rotatable blades 36 and fixed-variable vanes 38 (“vanes 38”) for directing air flow F through the fan section 12. The initially compressed air is provided to the core engine 28 and specifically through the core flow passage 24 to the compressor section 14.

The compressor section 14 includes a high pressure compressor 40 that feeds compressed air to a combustor 42 in the combustion section 16. The compressed air is mixed with fuel and ignited in the combustor 42 to produce a high energy gas flow stream. The high energy gas flow stream is expanded serially through a high pressure turbine 44 and a low pressure turbine 46. The low pressure turbine 46 is coupled to drive an inner shaft 48 that extends forward to drive the fan section 12. The high pressure turbine 44 is coupled to drive an outer shaft 50 to drive the high pressure compressor 40.

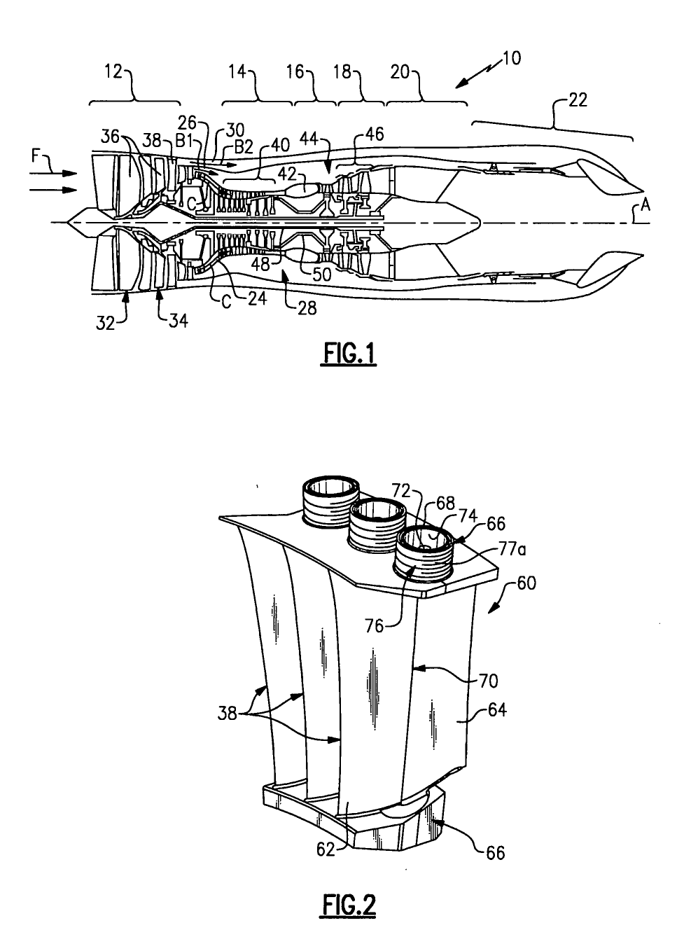

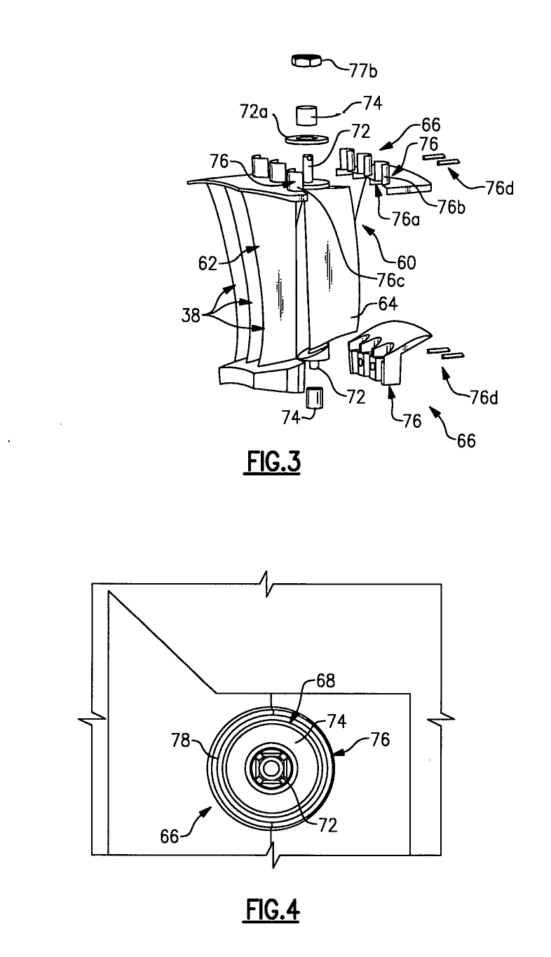

FIG. 2 illustrates an isolated view of several vane assemblies 60 in which the vanes 38 are included, and FIG. 3 illustrates an exploded view of the vane assemblies 60. In this example, the vanes 38 are provided in a unit “3-pack,” although it is to be understood that additional vanes could be used in a unit pack, or the unit pack could be a double or single pack. In each vane assembly 60, the vane 38 includes a fixed airfoil section 62 and a variable airfoil section 64 next to the fixed airfoil section 62. The variable airfoil section 64 is movable relative to the fixed airfoil section 62. In this regard, the variable airfoil section 64 is pivotably mounted at an end thereof in a joint 66 with a variable joint gap 68 that controls a size of an airfoil gap 70 between the fixed airfoil section 62 and the variable airfoil section 64. That is, the size of the variable joint gap 68 directly influences the size of the airfoil gap 70. As will be appreciated, the variable airfoil section 64 is pivotably mounted in similar joints 66 at both a radially outer and radially inner end of the variable airfoil section 64. Thus, although a representative one of the joints 66 may be described herein, the fixed-variable vane assembly 60 can include such joints 66 at both ends of the variable airfoil section 64. Alternatively, the fixed-variable vane assembly 60 could include only one such joint 66 at one end of the variable airfoil section 64.

In the illustrated example, the joint 66 includes a pivot member 72, a bushing 74 that receives the pivot member 72, and a fixed receiver 76 that has an opening 76a that receives the bushing 74. For instance, the pivot member 72 is a cylindrical rod, but could alternatively have a threaded geometry or non-cylindrical geometry. The bushing 74 in this example is cylindrical and has a central opening that geometrically corresponds to, and receives, the pivot member 72. As can be appreciated, the bushing 74 could have other, non-cylindrical geometries. Optionally, a washer 72a can be used on the pivot member 72 to support the bushing 74.

In this example, the fixed receiver 76 is split and includes two receiver sections 76b/76c that are secured together using pins 76d to capture the bushing 74 there between. As can be appreciated, additional or other mechanisms can be used to secure the two receiver sections 76b/76c. The fixed receiver 76 has a threaded outside surface 77a that receives a nut 77b that secures the receiver sections 76b/76c together. Each receiver section 76b/76c in this example includes multiple openings 76a such that, once assembled, the fixed receiver 76 can receive multiple bushings 74 of multiple, circumferentially-arranged fixed-variable vane assemblies 60. As will be appreciated, although shown in a triple configuration, the fixed receiver 76 could also include additional openings 76a, or could be in a double or single configuration.

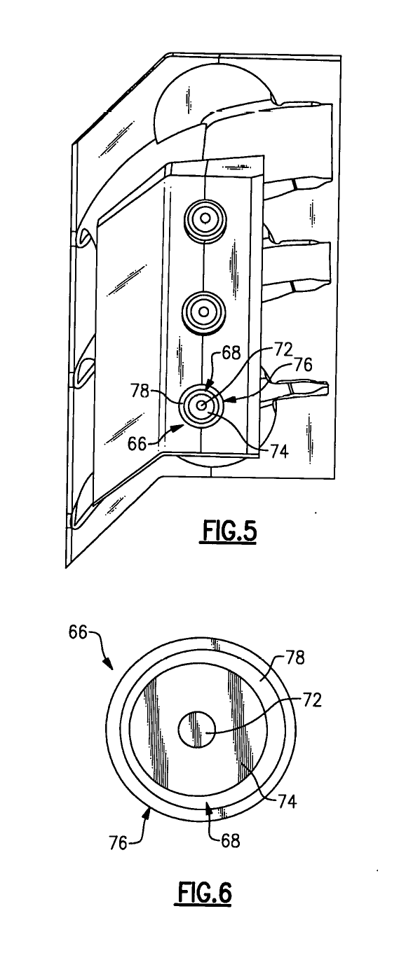

FIG. 4 shows a radial inward view of the joint 66 from the radially outer end of the vane assembly 60, and FIG. 5 shows a radial outward view of the joint 66 from the radially inner end of the vane assembly 60. The variable joint gap 68 is located between the outside of the bushing 74 and the side of the opening 76a of the fixed receiver 76. A potting material 78 is received in the variable joint gap 68. Prior to application of the potting material 78, the variable joint gap 68 is adjustable, to adjust the size of the airfoil gap 70. The potting material 78 then locks the variable joint gap 68 and thus locks in the desired size of the airfoil gap 70. In this regard, by adjusting the size of the variable joint gap 68 during assembly of the fixed-variable vane assembly 60, the corresponding size of the airfoil gap 70 can be controlled to obtain a desired size of the airfoil gap 70. In some examples, as shown in FIG. 6, the final adjusted position of the bushing 74 relative to the fixed receiver 76 is such that the variable joint gap 68 is non-uniform around the circumference of the bushing 74. That is, the bushing 74 and opening 76a of the fixed receiver 76 are non-concentric.

The potting material 78 is selected to appropriately lock the variable joint gap 68. The terms “lock” or “locking” of the variable joint gap 68 refer to the bushing 74 being substantially immovable relative to the fixed receiver 76. Thus, whereas the bushing 74 is adjustably movable relative to the fixed receiver 76 without the potting material 78, with the potting material 78 the bushing 74 is substantially immovable relative to the fixed receiver 76.

In some examples where very rigid locking is desired, a very strong and rigid potting material 78 can be used. In further examples, the potting material 78 is a polymeric-based material, such as a thermoplastic-based material or an elastomeric-based material. The polymeric-based material can include additives and reinforcement as appropriate to obtain desired properties. Example thermoset-based materials can include, but not limited to, epoxy-based materials. Example elastomeric-based material can include, but are not limited to, silicone-based materials. The polymeric-based material, and particularly the elastomeric-based material, can also serve as a vibration damper to mitigate vibrations in the variable airfoil section 64.

The examples herein also embody a method of establishing sizing of the airfoil gap 70 in the fixed-variable vane assembly 60. An example method can include pivotably mounting the variable airfoil section 64 in the joint 66 next to the fixed airfoil section 62. The size of the variable joint gap 68 in the joint 66 can then be adjusted to obtain a desired size of the airfoil gap 70 between the fixed airfoil section 62 and the variable airfoil section 64. The adjustment of the size of the variable joint gap 68 can include holding at least the variable airfoil section 64 in a fixture and adjusting the position of the variable airfoil section 64 to thus adjust the size of the variable joint gap 68. The fixed airfoil section 62 can also be held in the fixture or in a separate fixture.

Once a desired airfoil gap 70 is obtained by the adjustments, the potting material 78 is applied into the variable joint gap 68 to thus lock in the desired size of the airfoil gap 70. Depending upon the composition of the potting material 78, a curing step may be needed for solidification before the fixture(s) can be removed. In further examples, the composition of the potting material 78 is selected to cure at relatively low temperatures to avoid exposing the fixed-variable vane assembly 60 to temperatures that could damage other components. Thus, the method permits tight control over the size of the airfoil gap 70 by adjustment of the size of the variable joint gap 68 and then locking in the airfoil gap 70 by applying the potting material 78 into the variable joint gap 68. With tighter tolerances on the airfoil gap 70, less airflow escapes between the fixed airfoil section 62 and the variable airfoil section 64, thus enhancing aerodynamic efficiency of the vane 38.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A fixed-variable vane assembly comprising:
a vane that includes a fixed airfoil section and a variable airfoil section next to the fixed airfoil section, the variable airfoil section is pivotably mounted at an end thereof in a joint with a variable joint gap that controls a size of an airfoil gap between the fixed airfoil section and the variable airfoil section; and
a potting material in the variable joint gap, and the potting material locks the variable joint gap and locks in the size of the airfoil gap.

2. The fixed-variable vane assembly as recited in claim 1, wherein the joint includes a pivot member, a bushing that receives the pivot member, and a fixed receiver that has an opening that receives the bushing, and the variable joint gap is between the bushing and a side of the opening.

3. The fixed-variable vane assembly as recited in claim 2, wherein the fixed receiver has a threaded outside surface that receives a nut.

4. The fixed-variable vane assembly as recited in claim 1, wherein the variable joint gap has a non-uniform dimension.

5. The fixed-variable vane assembly as recited in claim 1, wherein the potting material is a vibration damper.

6. The fixed-variable vane assembly as recited in claim 1, wherein the potting material is a polymeric-based material.

7. The fixed-variable vane assembly as recited in claim 1, wherein the potting material is an elastomeric-based material.

8. The fixed-variable vane assembly as recited in claim 1, wherein the potting material is a silicone-based material.

9. A fixed-variable vane assembly comprising:
a fixed airfoil section;
a variable airfoil section next to the fixed airfoil section, the variable airfoil section includes at an end thereof a pivot member;
a bushing that receives the pivot member;
a fixed receiver that has an opening that receives the bushing, the opening is larger than the bushing such that there is a variable joint gap between a side of the opening and the bushing; and
a potting material in the variable joint gap.

10. The fixed-variable vane assembly as recited in claim 9, wherein the fixed receiver has a threaded outside surface that receives a nut.

11. The fixed-variable vane assembly as recited in claim 9, wherein the variable joint gap has a non-uniform dimension.

12. The fixed-variable vane assembly as recited in claim 9, wherein the potting material is a vibration damper.

13. The fixed-variable vane assembly as recited in claim 9, wherein the potting material is a polymeric-based material.

14. The fixed-variable vane assembly as recited in claim 9, wherein the potting material is an elastomeric-based material.

15. The fixed-variable vane assembly as recited in claim 9, wherein the potting material is a silicone-based material.

16. The fixed-variable vane assembly as recited in claim 9, wherein the variable joint gap controls size of an airfoil gap between the fixed airfoil section and the variable airfoil section.

17. A method of establishing sizing of an airfoil gap in a fixed-variable vane assembly, the method comprising:
pivotably mounting a variable airfoil section in a joint next to a fixed airfoil section;
adjusting a size of a variable joint gap in the joint to obtain a desired size of an airfoil gap between the fixed airfoil section and the variable airfoil section; and
applying a potting material in the variable joint gap to lock in the desired size of the airfoil gap.

18. The method as recited in claim 17, wherein the adjusting includes holding at least the variable airfoil section in a fixture.

19. The method as recited in claim 17, wherein the joint includes a pivot member, a bushing that receives the pivot member, and a fixed receiver that has an opening that receives the bushing, and the variable joint gap is between the bushing and a side of the opening.
